(19) United States
(12) Patent Application Publication
(10) Pub. No.: US 2004/0069448 A1
(43) Pub. Date: Apr. 15, 2004

(54) Exhaust heat utilization system, exhaust heat utilization method, and semiconductor production facility

(76) Inventors: Osamu Suenaga, Nirasaki-shi (JP); Sadao Kobayashi, Shinjuku-Ku (JP); Naoki Mori, Shinjuku-Ku (JP); Hiromu Ito, Shinjuku-Ku (JP)

Correspondence Address: Crowell & Moring, P O Box 14300, Washington, DC, 20044-4300, US

(21) Appl. No.: 10/468,368

(22) PCT Filed: Feb. 18, 2002
(86) PCT No.: PCT/JP02/01371

(30) Foreign Application Priority Data
Feb. 20, 2001 (JP) 2001-44216

(51) Int. Cl. F24H 3/00; F25B 27/00; F24H 7/00; F27D 15/02

(52) U.S. Cl. 165/47; 62/238.6; 432/30; 432/81

(57) ABSTRACT

An exhaust-heat utilization system is constructed which can achieve energy saving of semiconductor manufacturing facilities by reusing a warmed cooling-water, as a heating source, exhausted from semiconductor manufacturing apparatuses. Supply a low-temperature cooling-water having a temperature substantially equal to a room temperature to the semiconductor manufacturing apparatuses (2, 4, 6, 8, 10) through a low-temperature cooling-water line (12). Supply a medium-temperature cooling-water to the semiconductor manufacturing apparatus (8) through a medium-temperature cooling-water supply line (30), the medium-temperature cooling-water being exhausted from the semiconductor manufacturing apparatuses and having a temperature higher than the room temperature. Supply, as a heating source, a high-temperature cooling-water to a the semiconductor apparatuses (6, 10) through a high-temperature cooling-water supply line (32), the high-temperature cooling-water exhausted from the semiconductor manufacturing apparatuses (2, 4) and having a temperature still higher than the medium-temperature cooling-water.

### TECHNICAL FIELD

The present invention relates to exhaust-heat utilization systems and exhaust-heat utilization methods of semiconductor manufacturing-facilities and semiconductor manufacturing facilities and, more particularly, to an exhaust-heat utilization system and an exhaust-heat utilization method that reuse a cooling water, which is discharged from various kinds of semiconductor manufacturing apparatuses, for cooling or heating in other semiconductor manufacturing apparatuses, and a semiconductor manufacturing facility having such an exhaust-heat utilization system.

### BACKGROUND ART

Semiconductor manufacturing apparatuses used in semiconductor manufacturing facilities and peripheral apparatuses thereof require cooling for controlling a temperature rise of the apparatuses. Additionally, among these apparatuses, there are apparatuses that require cooling in a semiconductor manufacturing process. On the other hand, among these apparatuses, there are apparatuses that require a heating process in a semiconductor manufacturing process, and, thus, heat sources are provided to such apparatuses.

In a conventional semiconductor manufacturing facility, cooling of an apparatus is carried out generally by supplying cooling water to the apparatus and circulating through the interior of the apparatus. That is, cooling water is led to the apparatus from a cooling-water supply line through which the cooling water flows, and the cooling water which is warmed by absorbing heat from the apparatus is returned to a cooling-water recovery line. The cooling water which returned to the cooling-water recovery line is again supplied to a cooling-water supply line, after being cooled by a cooling apparatus containing a refrigerating machine etc. Additionally, in the apparatuses that require a heating process, heating is performed generally using an electric heater as a heating source.

In the conventional semiconductor manufacturing facility, cooling and heating in these semiconductor manufacturing apparatuses are independently performed for each apparatus, and exchange of heat between the apparatuses is not performed.

FIG. 1 is an illustration showing an example of a cooling system in the conventional semiconductor manufacturing facility. The semiconductor manufacturing facility shown in FIG. 1 is a facility which processes silicon wafers or the like so as to manufacture semiconductor devices, and a vertical heat treatment apparatus 2, a vertical heat treatment apparatus 4, a wafer cleaning apparatus 6, a coater/developer apparatus 8 and an etching apparatus 10, etc. are installed therein.

The vertical heat treatment apparatus 2, the vertical heat treatment apparatus 4, the wafer cleaning apparatus 6, a coater/developer apparatus 8 and the etching apparatus 10 require cooling of the apparatus, respectively. Cooling of these apparatuses is performed using a cooling-water circulation system. The cooling-water circulation system has a cooling-water supply line 12 and a cooling-water recovery line 14. Each apparatus is supplied with cooling water from the cooling-water supply line 12, and the apparatus is cooled by the cooling water circulating within each apparatus and absorbing heat. The cooling water which is warmed by absorbing heat is exhausted to the cooling-water recovery line 14, and is supplied to warmed cooling-water tank 16 by flowing through the cooling-water recovery line 14.

Generally, the cooling water supplied to the cooling-water supply line 12 has a temperature in the range of a room temperature, for example, 23° C. An amount of the cooling water supplied to each apparatus is controlled in accordance with an amount of heat radiated by each apparatus so that the warmed cooling-water exhausted from each apparatus is about 30° C. The cooling water, which is exhausted from each apparatus and has been warmed at about 30° C., is temporarily stored in the warmed cooling-water tank 16 through the cooling-water recovery line 14. Thereafter, the warmed cooling-water stored in the warmed cooling-water tank 16 is delivered to a heat exchanger 20 through the cooling-water circulation line 18, and is cooled to the temperature of 23° C. again by being cooled by the heat exchanger 20. Then, the cooling water of 23° C. from the heat exchanger 20 is supplied to the cooling-water supply line 12 by the cooling-water circulation pump 22.

In the above-mentioned conventional cooling system shown in FIG. 1, the heat exchanger 20 is supplied with the cooling water or refrigerant cooled below 10° C. by the cooling apparatus 24 containing a refrigerating machine so as to cool the cooling water of 30° C. at 23° C. by heat-exchanging between the cooling water of 30° C. and the cooling water or refrigerant cooled below 10° C. Therefore, in the conventional cooling system shown in FIG. 1, the cooling apparatus 24 recovers all the heat exhausted through the cooling water from each of the apparatuses 2, 4, 6, 8 and 10, and, thus, a load to the cooling apparatus 24 (refrigerating machine) is very large. Therefore, the facility cost of the cooling apparatus 24 is very high, and the running cost of the cooling apparatus 24 is also increased.

Additionally, the heat recovered by the cooling apparatus 24 is merely emitted into atmosphere without reusing a huge amount of heat exhausted from each of the apparatuses 2, 4, 6, 8 and 10, and no measures are taken from a viewpoint of energy saving.

### DISCLOSURE OF INVENTION

It is a general object of the present invention to provide an improved and useful exhaust-heat utilization system, exhaust-heat utilization method and semiconductor manufacturing facility in which the above-mentioned problems are eliminated.

A more specific object of the present invention is to provide an exhaust-heat utilization system and exhaust-heat utilization method which can achieve energy saving of semiconductor manufacturing facilities by reusing a warmed cooling-water, as a heating source, exhausted from semiconductor manufacturing apparatuses.

In order to achieve the above-mentioned objects, there is provided according to one aspect of the present invention an exhaust-heat utilization system of a semiconductor manufacturing facility having a plurality of semiconductor manufacturing apparatuses, comprising: a low-temperature cooling-water supply line for supplying to the semiconductor manufacturing apparatuses a low-temperature cooling-water having a temperature substantially equal to a room temperature; a medium-temperature cooling-water supply line for supplying a medium-temperature cooling-water to a first predetermined semiconductor manufacturing apparatus, the medium-temperature cooling-water being exhausted from the semiconductor manufacturing apparatuses and having a temperature higher than the room temperature; and a high-temperature cooling-water supply line for supplying, as a heating source, a high-temperature cooling-water to a third predetermined semiconductor manufacturing apparatus, the high-temperature cooling-water being exhausted from a second predetermined semiconductor manufacturing apparatus and having a temperature higher than a temperature of the medium-temperature cooling-water.

The exhaust-heat utilization system according to the above-mentioned invention may further comprise: a medium-temperature cooling-water tank for temporarily storing the medium-temperature cooling-water exhausted from the semiconductor manufacturing apparatuses; a medium-temperature cooling-water circulation line for supplying the medium-temperature cooling-water stored in said medium-temperature cooling-water tank to said medium-temperature cooling-water supply line; a low-temperature cooling-water circulation line for supplying the medium-temperature cooling-water stored in said medium-temperature cooling-water tank to said low-temperature cooling-water supply line; and a water-cooling type cooling apparatus provided to said low-temperature cooling-water circulation line so as to cool the medium-temperature cooling-water from said medium-temperature cooling-water tank.

Additionally, the above-mentioned exhaust-heat utilization system may further comprise a heat exchanger provided to said low-temperature cooling-water circulation line so as to cool the cooling water from said water-cooling type cooling apparatus to be the low-temperature cooling-water. Further, the above-mentioned exhaust-heat utilization system may further comprise a high-temperature cooling-water tank which temporarily stores a high-temperature cooling-water exhausted from the semiconductor manufacturing apparatuses, wherein said high-temperature cooling-water supply line may be connected to said high-temperature cooling-water tank.

In an embodiment of the present invention, said first predetermined semiconductor manufacturing apparatus is a coater/developer apparatus. Additionally, said second predetermined semiconductor manufacturing apparatus is a heat treatment apparatus having a heating furnace. Further, said third predetermined semiconductor manufacturing apparatus includes at least one of a wafer cleaning apparatus and an etching apparatus.

Additionally, there is provided according to another aspect of the present invention an exhaust-heat utilization method of a semiconductor manufacturing facility having a plurality of semiconductor manufacturing apparatuses, comprising the steps of: supplying a low-temperature cooling-water having a temperature substantially equal to a room temperature to the semiconductor manufacturing apparatuses; supplying a medium-temperature cooling-water to a first predetermined semiconductor manufacturing apparatus, the medium-temperature cooling-water being exhausted from the semiconductor manufacturing apparatuses and having a temperature higher than the room temperature; and supplying, as a heating source, a high-temperature cooling-water to a third predetermined semiconductor apparatus as a heating source, the high-temperature cooling-water exhausted from a second predetermined semiconductor manufacturing apparatus and having a temperature still higher than the medium-temperature cooling-water.

The exhaust-heat utilization method according to the above-mentioned invention may further comprise the steps of: temporarily storing the medium-temperature cooling-water exhausted from the semiconductor manufacturing apparatus; supplying a part of the stored medium-temperature cooling-water to said first predetermined semiconductor manufacturing apparatus; and cooling a remaining part of the stored medium-temperature cooling-water by a water-cooling type cooling apparatus and supplying the cooled medium-temperature cooling-water to the semiconductor manufacturing apparatuses. Additionally, the exhaust-heat utilization method according to the present invention may further comprise a step of cooling further the medium-temperature cooling-water cooled by the water-cooling type cooling apparatus by a heat exchanger.

Additionally, there is provided according to another aspect of the present invention a semiconductor manufacturing facility, comprising: a plurality of semiconductor manufacturing apparatuses; a low-temperature cooling-water supply line for supplying to the semiconductor manufacturing apparatuses a low-temperature cooling-water having a temperature substantially equal to a room temperature; a medium-temperature cooling-water supply line for supplying a medium-temperature cooling-water to a first predetermined semiconductor manufacturing apparatus, the medium-temperature cooling-water being exhausted from the semiconductor manufacturing apparatuses and having a temperature higher than the room temperature; and a high-temperature cooling-water supply line for supplying, as a heating source, a high-temperature cooling-water to a third predetermined semiconductor manufacturing apparatus, the high-temperature cooling-water being exhausted from a second predetermined semiconductor manufacturing apparatus and having a temperature higher than a temperature of the medium-temperature cooling-water.

The semiconductor manufacturing facility according to the above-mentioned present invention may further comprise a medium-temperature cooling-water tank for temporarily storing the medium-temperature cooling-water exhausted from the semiconductor manufacturing apparatuses; a medium-temperature cooling-water circulation line for supplying the medium-temperature cooling-water stored in said medium-temperature cooling-water tank to said medium-temperature cooling-water supply line; a low-temperature cooling-water circulation line for supplying the medium-temperature cooling-water stored in said medium-temperature cooling-water tank to said low-temperature cooling-water supply line; and a water-cooling type cooling apparatus provided to said low-temperature cooling-water circulation line so as to cool the medium-temperature cooling-water from said medium-temperature cooling-water tank.

Additionally, the semiconductor manufacturing facility according to the present invention may further comprise a heat exchanger provided to said low-temperature cooling-water circulation line so as to cool the cooling water from said water-cooling type cooling apparatus to be the low-temperature cooling-water. Further, the semiconductor manufacturing facility according to the present invention may further comprise a high-temperature cooling-water tank which temporarily stores a high-temperature cooling-water exhausted from the semiconductor manufacturing apparatuses, wherein said high-temperature cooling-water supply line may be connected to said high-temperature cooling-water tank.

According to above-mentioned invention, a part of the medium-temperature cooling-water exhausted from each semiconductor manufacturing apparatus can be supplied to a part of the semiconductor manufacturing apparatus that requires a heating process, and, thus, the heat conventionally discarded through the cooling water can be reused. Additionally, only the high-temperature cooling-water exhausted from a predetermined semiconductor manufacturing apparatus is recovered and used as a heating source of other semiconductor manufacturing apparatuses, and the heat of the cooling water can be reused for a heating process which requires a heating temperature higher than the temperature of the medium-temperature cooling-water. Thus, since a part of heat of the warmed cooling-water exhausted from the semiconductor manufacturing apparatuses, which heat was conventionally discarded by the cooling apparatus through the heat exchanger, is reused for the heating process of other semiconductor manufacturing apparatuses, energy saving of the whole semiconductor manufacturing facility can be attained.

Additionally, there is provided according to another aspect of the present invention a heat recovery system of a semiconductor manufacturing plant having a plurality of semiconductor manufacturing apparatuses and an outside-air conditioning unit which supplies an outside air to the semiconductor manufacturing apparatuses after applying an air-conditioning process, comprising two cooling-water systems that are a cooling-water supply system which supplies a cooling water of a room temperature for cooling said semiconductor manufacturing apparatuses, and a cooling-water recovery system including piping, a tank and a pump for recovering the cooling water that is exhausted after cooling said semiconductor manufacturing apparatuses, wherein the cooling water exhausted from said semiconductor manufacturing apparatuses and recovered by said cooling-water recovery system is supplied to other semiconductor manufacturing apparatuses requiring heating and/or said outside-air conditioning unit.

In the above-mentioned heat recovery system, it is preferable that said semiconductor manufacturing apparatuses are vertical-type furnaces which thermally oxidize silicon wafers, and the cooling water recovered by said cooling-water recovery system is supplied to an air heater of said outside-air conditioning unit.

According to the above-mentioned invention, the warmed cooling water which is exhausted from a semiconductor manufacturing apparatus can be reused as a heating source of the outside-air conditioning unit that consumes large energy as a heat source, and the energy consumption by the whole semiconductor plant can be greatly reduced.

Other objects, features and advantages of the present invention will become more apparent from the following detailed description when read in conjunction with the accompanying drawings.

### BRIEF DESCRIPTION OF THE DRAWINGS

FIG. 1 is an illustration of a cooling system of a conventional semiconductor manufacturing facility.

FIG. 2 is an illustration of an exhaust-heat utilization system of a semiconductor manufacturing facility according to an embodiment of the present invention.

FIG. 3 is an illustration of a heat recovery system of a semiconductor manufacturing plant according to another embodiment of the present invention.

### BEST MODE FOR CARRYING OUT THE INVENITON

A description will now be given, with reference to the drawings, of an embodiment of the present invention.

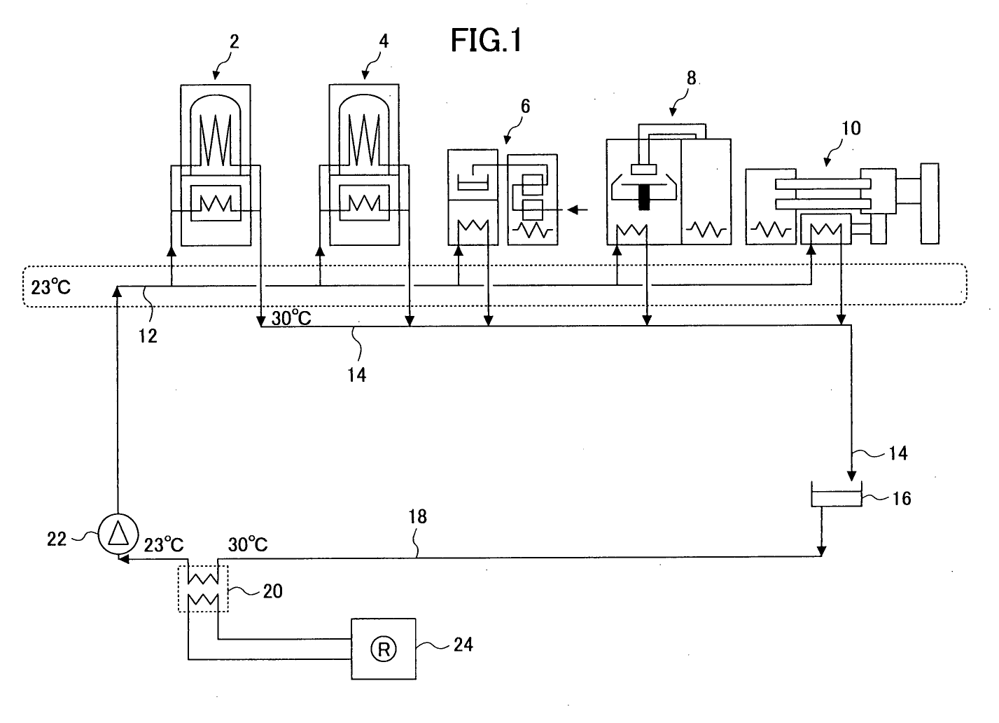

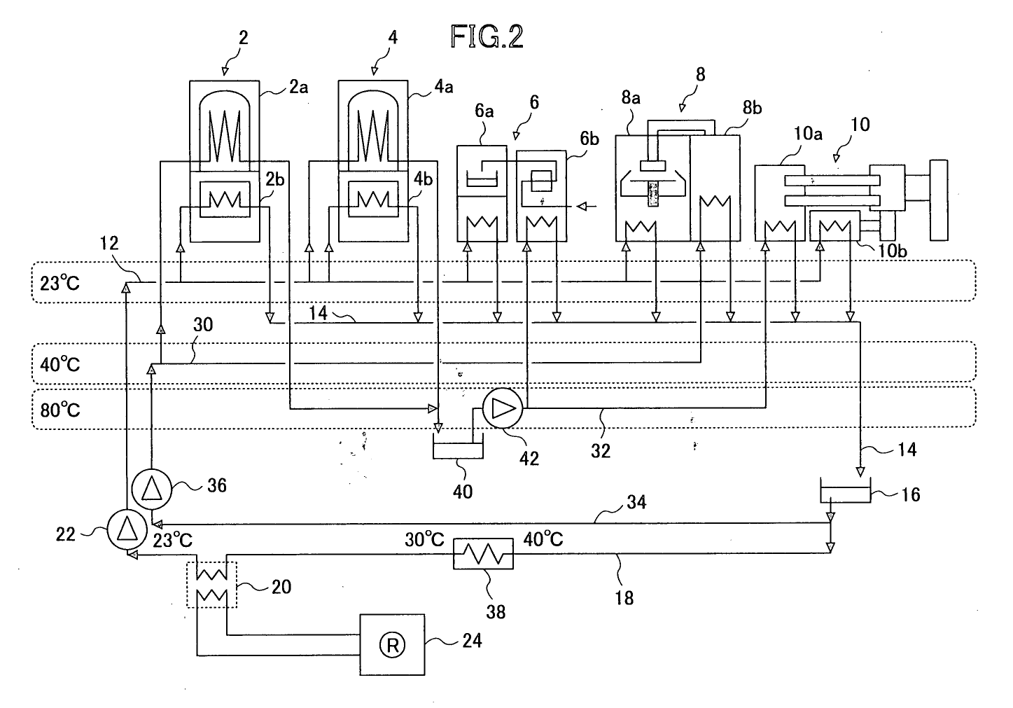

FIG. 2 is an illustration of a structure of an exhaust-heat utilization system according to the embodiment of the present invention. In FIG. 2, parts that are the same as the parts shown in FIG. 1 are given the same reference numerals, and descriptions thereof will be omitted.

First, the basic concept of the exhaust-heat utilization system according to the embodiment of the present invention is explained. The exhaust-heat utilization system of the present invention is one that reuses a cooling water exhausted from each semiconductor manufacturing apparatus as a heating source or a cooling source required by other semiconductor manufacturing apparatuses. That is, the cooling water exhausted from a semiconductor manufacturing apparatus from among semiconductor manufacturing apparatuses in a semiconductor manufacturing facility is reused as a relatively low-temperature heating source that is required by other apparatuses. Additionally, the warmed cooling water exhausted from each apparatus is supplied again to the apparatus of which part that needs cooling is at a relatively high-temperature so as to perform cooling. Hereafter, the cooling water which is warmed and exhausted from semiconductor manufacturing apparatuses is referred to as warmed cooling-water.

In order to perform the above-mentioned exhaust-heat utilization, in the exhaust-heat utilization system according to the present embodiment, a cooling water supply line is divided into three lines that are a low-temperature line (for example, 23° C.), a medium-temperature line (for example, 40° C.) and a high-temperature line (for example, 80° C.). Then, the cooling water of the low-temperature, medium temperature and high-temperature is supplied, if necessary, to each semiconductor manufacturing apparatus as a cooling source or a heating source. As for the cooling water of the medium-temperature or the high-temperature, the warmed cooling-water exhausted from the semiconductor manufacturing apparatuses is used as it is.

Next, a description will be given of each semiconductor manufacturing apparatus shown in FIG. 2 from a viewpoint of exhaust-heat utilization.

Vertical heat treatment apparatuses 2 and 4 are apparatuses which apply a heat-treatment to semiconductor wafers, and have heating furnaces 2a and 4a which process the wafers at a high-temperature of about 1000° C. Therefore, the warmed cooling-water of the medium-temperature (for example, 40° C.) exhausted from other semiconductor manufacturing apparatuses is sufficient for cooling the periphery of the heating furnaces. After cooling the heating furnace 2a, the warmed cooling-water is exhausted from the apparatus as a high-temperature warmed cooling water. However, the vertical heat treatment apparatuses 2 and 4 also have wafer conveyance parts 2b and 4b, and it is required to supply the normal low-temperature (about 23° C.) to the conveyance parts 2b and 4b.

The wafer cleaning apparatus 6 is an apparatus that washes semiconductor wafer by a warmed deionized water (DI water), and has a DI water heating part 6b for warming the DI water adjacent to a washing part 6a. The washing part 6a must be cooled since the washing part 6a uses the warmed DI water, and a normal low-temperature cooling-water (for example, 23° C.) is used for cooling. On the other hand, the DI water heating part 6b heats the DI water of a room temperature (20-25° C.) at a temperature of about 50° C.-60° C., and supplies it to the washing part 6a. Therefore, a heating source is required for the DI water heating part 6b, and, conventionally, an electric heater has been used as the heating source. Here, the heating temperature of the DI water is about 50° C.-60° C. as mentioned above, which is a temperature range sufficiently heated by heat exchange using the warmed cooling water of a high-temperature (for example, 80° C.).

The coater/developer apparatus 8 generally has a coater/developer part 8a and an air-conditioning part 8b. In the coater/developer part 8a, a photoresist is applied by a coater and a process for developing is performed by a developer. A solvent is added to the photoresist prior to be applied to the wafer so as to be liquefied, and a resist layer is formed on a wafer by causing the solvent to be evaporated. Since the viscosity of the liquefied photoresist greatly depends on an ambient temperature, the temperature of the air in the coater/developer part 8a must be maintained constant (for example, 23° C.) Therefore, it is necessary to always cool the coater/developer part 8a by a low-temperature cooling-water (for example, 23° C.).

Additionally, it is necessary to maintain the humidity of an air inside the coater/developer part 8a constant since an evaporation rate of the solvent in the applied photoresist is innfluenced by the humidity of the ambient air. Therefore, the air-conditioning part 8b is provided in the vicinity of the coater/developer part 8a so as to supply a temperature and humidity adjusted air.

Here, in order to adjust temperature and humidity, a dry air (air with low humidity) is prepared first by dehumidifying by cooling an air of a room temperature, and, then, the dray air is set at an appropriate humidity (for example, a relative humidity of 45%) by humidifying by let the dry air pass through a warmed water. During the humidification, the air is also heated simultaneously so as to be at a constant temperature (for example, 23° C.). At this time, in order to heat and humidify the cooled dry air, the medium-temperature (for example, 40° C.) warmed cooling-air can be used. Thus, there is an application which uses the medium-temperature (for example, 40° C.) warmed cooling-water in the air-conditioning part 8b of the coater/developer apparatus 8.

The etching apparatus 10 is an apparatus, which processes a wafer by dry etching. As for the dry etching, a reactant chemical etching using a radio frequency (RF) or a plasma etching is used. Since the wafer becomes a high temperature in such etching, a processing part 10a is provided with a chiller part for cooling a refrigerant for cooling the wafer (a placement table on which the wafer is placed). Although a refrigerant is cooled and is maintained normally at a low temperature, it is necessary to raise the temperature of the refrigerant so as to rapidly return to a room temperature when an etching process is completed. Thus, there is an application in the chiller part to use the high-temperature (for example, 80° C.) so as to warm the refrigerant. On the other hand, it is necessary to cool an RF generator 10b, which generates a radio frequency (RF) for performing dry etching, by the low-temperature (for example, 23° C.) cooling-water.

As mentioned above, the semiconductor manufacturing apparatus provided in a semiconductor manufacturing facility require a cooling source and a heating source of various temperatures, and the warmed cooling water exhausted from each apparatus can be reused by being supplied to other apparatuses as the heating source or the cooling source.

In the present embodiment, the cooling-water supply line 12 which supplies the cooling water of a normal low-temperature (for example, 23° C.) similar to the conventional one and the cooling-water recovery line 14 which recovers the warmed cooling-water exhausted from each apparatus are provided as shown in FIG. 2. In the present embodiment, an amount of cooling water supplied to each apparatus is controlled so that the temperature of the warmed cooling water exhausted to the cooling-water recovery line 14 is at about 40° C.

In the present embodiment, a medium-temperature cooling-water supply line 30 and a high-temperature cooling-water supply line 32 are provided in addition to the above-mentioned cooling-water supply line. The medium-temperature cooling-water supply line 30 is provided so as to supply to a semiconductor manufacturing apparatus the medium-temperature (for example, 40° C.) warmed cooling water (hereinafter, referred to as a medium-temperature cooling-water) exhausted from each semiconductor manufacturing apparatus as it is without cooling. Additionally, the high-temperature cooling-water supply line 32 is provided so as to supply to a predetermined semiconductor manufacturing apparatus the high-temperature (for example, 80° C.) warmed cooling-water (hereinafter, referred to as a high-temperature cooling water) exhausted from a predetermined semiconductor manufacturing apparatus. It should be noted that, in the following explanation, the cooling-water supply line 12 which supplies the low-temperature (for example, 23° C.) cooling water (hereinafter, referred to as a low-temperature cooling water) is referred to as a low-temperature cooling-water supply line 12.

After the medium-temperature cooling-water collected from each semiconductor manufacturing apparatus through the cooling-water recovery line 14 is temporarily stored in the medium-temperature cooling-water tank 16, a part thereof is supplied to the medium-temperature cooling-water supply line 30 by a medium-temperature cooling-water circulation pump 36 through a medium-temperature cooling-water circulation line 34. The remaining part of the medium-temperature cooling-water temporarily stored in the medium-temperature cooling-water tank 16 is delivered a heat exchanger 20 through the low-temperature cooling-water circulation line 18. In the present embodiment, a cooling tower 38 (water cooling type cooling apparatus) is provided before the heat exchanger 20 so as to cool the medium-temperature cooling water of about 40° C. flowing through the low-temperature cooling-water circulation line 18 down to about 30° C. The medium-temperature cooling-water cooled at 30° C. by the cooling tower 38 is cooled at 23° C. by the heat exchanger 20 so as to be the low-temperature cooling water, and, thereafter, supplied to the low-temperature cooling-water supply line 12 by the low-temperature cooling-water circulation pump 22.

On the other hand, the high-temperature cooling water of about 80° C. exhausted from the heating furnaces 2a and 4a of the vertical heat treatment apparatuses 2 and 4 from among the semiconductor manufacturing apparatuses are delivered to the high-temperature cooling water tank 40 and stored temporarily, and, thereafter, supplied to the high-temperature cooling-water supply line 32 by the high-temperature cooling-water circulation pump 42. Then, the high-temperature cooling water of the high-temperature cooling-water supply line 32 is supplied to the DI water heating part 6b of the wafer cleaning apparatus 6 as a heating source. Additionally, the high-temperature cooling water of the high-temperature cooling-water supply line 32 is supplied also to the chiller part of the processing part 10a of the etching apparatus 10.

The high-temperature cooling water supplied to the DI water heating part 6b and the chiller part of the processing part 10a turns to be the medium-temperature cooling water of about 40° C. by emitting heat so as to heat the DI water, and is exhausted to the cooling-water recovery line 14. Therefore, the heat of the high-temperature cooling water exhausted from the vertical heat treatment apparatuses 2 and 4 is used for heating of the DI water heating part 6b and the chiller part of the processing part 10a, and the high-temperature cooling water turns into the medium-temperature cooling water. That is, the heat conventionally discarded from the vertical heat treatment apparatuses 2 and 4 to outside the manufacturing facility is reused by the wafer cleaning apparatus 6 and the etching apparatus 10. Additionally, as mentioned above, the medium-temperature cooling water of about 40° C. supplied to the medium-temperature cooling-water supply line 30 is supplied to the air-conditioning part 8b of the coater/developer apparatus 8. Then, the medium-temperature cooling water is used as a heating source for heating and humidifying air, and is exhausted to the cooling-water recovery line 14. Therefore, a heating process using the heat of the medium-temperature cooling water is performed also in the air-conditioning part 8b so as to reuse the heat of the medium-temperature cooling water.

It should be noted that, in FIG. 2, the medium-temperature cooling water of about 40° C. is supplied to the heating furnace 2a of the vertical heat treatment apparatus 2 from the medium-temperature cooling-water supply line 30, and the low-temperature cooling water of about 23° C. is supplied to the heating furnace 4a of the vertical heat treatment apparatus 4 from the low-temperature cooling-water supply line 12. Since temperatures of the heating furnaces 2a and 4a of the vertical heat treatment apparatuses 2 and 4 are very high, a sufficient cooling effect can be obtained even if the low-temperature cooling water is not used but the medium-temperature cooling water is used. Therefore, if there is no inconvenience in the amount and temperature of the exhausted high-temperature cooling water, it is preferable to use the medium-temperature cooling water as much as possible for cooling a part, which becomes a high temperature.

As mentioned above, in the exhaust-heat utilization system according to the present embodiment, a part of heat of the warmed cooling-water exhausted from the semiconductor manufacturing apparatuses discarded by the cooling apparatus 24 through the heat exchanger 20 is reused to heating process of other semiconductor manufacturing apparatuses, thereby achieving energy saving of the whole semiconductor manufacturing facility.

Here, in the present embodiment, the cooling tower 38 is provided to the low-temperature cooling-water circulation line 18 so as to cool the medium-temperature cooling water to some extent, and the low-temperature cooling water is obtained by further cooling the cooling water from the cooling tower 38 by the heat exchanger 20. However, if an amount of the medium-temperature cooling water supplied to the medium-temperature cooling-water supply line 30 is large, and if an amount of the low-temperature cooling water delivered to the low-temperature cooling-water circulation line 18 becomes small, the medium-temperature cooling water of about 40° C. may be turned into the low-temperature cooling water of about 23° C. by cooling of the cooling tower 38 alone. Thereby, it is also possible to build an exhaust-heat utilization system, which does not use the heat exchanger 20 and the cooling apparatus 24.

In the above-mentioned embodiment, the low temperature (for example, 23° C.), the medium temperature (for example, 40° C.) and the high temperature (for example, 80° C.), which are the temperatures of the cooling water, are not limited to the specifically disclosed temperatures, and may be changed to, for example, 20° C. for the low temperature, 30° C. for the medium temperature and 60° C. for the high-temperature, if necessary.

Moreover, in the above-mentioned embodiment, the semiconductor manufacturing apparatuses used in the semiconductor manufacturing facility are not limited to the apparatuses shown in FIG. 2, and other semiconductor manufacturing apparatuses or peripheral apparatuses relating to semiconductor manufacturing may be used. Moreover, it is not limited to the semiconductor manufacturing apparatuses and the peripheral apparatuses, and may be apparatuses in other facilities located adjacent to the semiconductor manufacturing facility. For example, the warmed cooling water can also be used as a heating source of an air-conditioner of an office building which accompanies the semiconductor manufacturing facility.

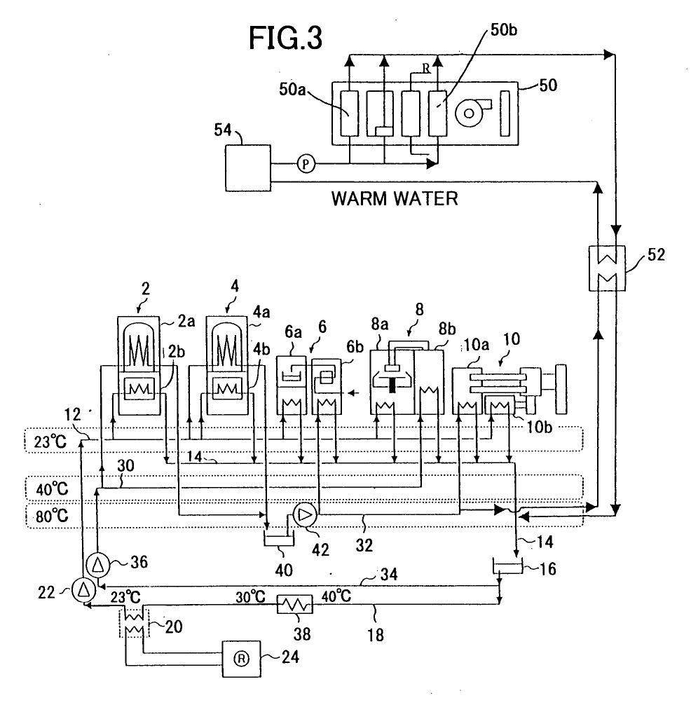

Next, a description will be given, with reference to FIG. 3, of a heat-recovery system of a semiconductor manufacturing plant according to another embodiment of the present invention. FIG. 3 is an illustration of the heat-recovery system of the semiconductor plant according to another embodiment of the present invention. In FIG. 3, parts that are the same as the parts shown in FIG. 2 are given the same reference numerals, and descriptions thereof will be omitted.

The semiconductor manufacturing facility (semiconductor manufacturing plant) according to the present invention has basically the same structure as the above-mentioned embodiment except for having an outside air-conditioning unit 50, which uses the medium-temperature cooling water as a heating source. The outside air-conditioning unit 50 is an air-conditioning unit, which produces a clean air to be supplied to a clean room in which semiconductor manufacturing apparatuses are installed. The outside air-conditioning unit 50 means a facility that draws and cleans an outside air, then cools the air to a temperature about 10° C., heats the air to a room temperature so as to make the relative humidity near 40% and supplies the air to the clean room.

Conventionally, the warmed cooling-water exhausted from semiconductor manufacturing apparatuses (for example, vertical heat-treatment furnaces 2 and 4) is reused as a cooling water after returning to a heat exchanger to which a cold water is supplied from a refrigeration machine so as to cool the warmed cooling-water to a room temperature. In the present embodiment, similar to the above-mentioned embodiment, in order to carry out the heat recovery from the warmed cooling-water which comes out by cooling of the semiconductor manufacturing apparatuses, the facility is provided with two cooling-water piping systems by adding a warmed cooling-water recycle system, which comprises piping, a water tank and a pump, to collect and recirculate the warmed cooling-water. The warmed cooling-water recycle system includes: piping for exhausting a high-temperature cooling-water: a high-temperature cooling-water tank 40 for storing the high-temperature cooling-water, a semiconductor manufacturing apparatus (for example, the wafer cleaning apparatus 6 and the etching apparatus 10) which uses the high-temperature cooling water from the high-temperature cooling-water tank 40 and/or piping to the outside air-conditioning unit 50 and a high-temperature cooling-water circulation pump 42.

In the structure shown in FIG. 3, a heat exchanger 52 is provided in the middle of the piping from the tank 40 to the outside air-conditioning unit 50. The heat exchanger 52 performs a heat exchange between the used warm water exhausted from a preheating coil 50a and a reheating coil 50b of the outside air-conditioning unit 50 and the high-temperature cooling water supplied from the high-temperature cooling-water tank 40 so as to raise the temperature of the used war water, and returns it to the warm-water tank 54 as a heating source. Thus, the warm water, which is supplied from the warm-water tank 54 and used for air heating by the outside air-conditioning unit 50, is heated by the heat exchanger 52, and is again used as a warm water for heating. As a source of heating of the warm water in this case, the high-temperature cooling water from the semiconductor manufacturing apparatuses is used.

In the present embodiment, the high-temperature cooling water used for heating in the semiconductor manufacturing apparatuses and/or the outside air-conditioning unit 50 is cooled below 30° C., and is usable again as a cooling water for the semiconductor manufacturing apparatuses. For this reason, like the conventional cooling-water system, an expensive refrigeration machine and an expensive heat exchanger are unnecessary, and there is an advantage that the operation power is further reducible.

The heat reuse system according to the present embodiment is applicable to a case where there is no problem occurs even if a temperature control is relatively rough. In the case of the cooling-water piping system of three lines, that is, in a case of a semiconductor manufacturing apparatus requiring a severe control at 60° C., it is very preferable since a necessary heating can be performed easily by supplying a warmed cooling water at the aimed temperature. However, in a case of heating the outside air-conditioning unit 50, for example, there may be a case in which a heat capacity to be heated is large and the warmed water alone is insufficient. For this reason, a steam heater or an electric heater for heating, which has been used conventionally, is used so that the temperature of the warm water exhausted from the outside air-conditioning unit 50 can be returned to a room temperature. Therefore, the warmed cooling-water supplied to the heat exchanger 52 is not always set to a certain fixed temperature. In such a case, one warmed cooling water line from among the three piping lines can be saved by making it two piping lines. Thus, the temperature of the warmed cooing water to be reused is preferably the medium-temperature of 30° C.-50° C. It is because the heat-exchange efficiency is low below 30° C., and it is necessary, if above 50° C., to thermally insulate the piping by winding a high-grade heat insulating material around the piping and use a special material for packing to be used.

In an above-mentioned embodiment, as for the semiconductor manufacturing apparatus which exhaust a warmed cooling water to be reused, the vertical heat-treatment furnaces 2 and 4 are preferable, which thermally oxidize silicon wafers and exhaust a large amount of warmed cooling water at a high temperature. Additionally, as mentioned above, it is preferable that the place utilizing the heat of the high-temperature cooling water be the air heater (the preheating coil 50a and the reheating coil 50b) of the outside air-conditioning unit 50. Thus, if the warmed cooling water from the vertical heat-treatment furnace, which exhausts a large amount of warmed cooling water at a relatively high temperature, is used for heating the warm water as a heating source for the air heater of the outside air-conditioning unit 50, an energy for outside-air processing can be efficiently saved. In this case, although it is necessary to provide the heat exchanger 52 for the air heater, an amount of steam or an amount of electricity for raising to a room temperature can be greatly saved even if, for example, a steam heater or an electric heater is used as an auxiliary heating apparatus since it can heat up to a temperature near a room temperature by the heat exchanger 52.

It is assumed that, as a case in which the heat reuse system shown in FIG. 3 is used, the processing air flow of the outside air conditioning unit 50 is 10000 m3/h and the thermal load thereof is about 300,000 Mcals. Additionally, assuming that a usable amount of recovered heat from among production cooling-water exhaust heat of the semiconductor manufacturing apparatuses is 100,000 Mcals annually, about ⅓ of the amount of thermal load necessary for one year can be saved by using the warmed cooling-water exhausted from the semiconductor manufacturing apparatuses. Additionally, the heat-source capacity of a refrigerating machine can be decreased by ten percent by reduction of the cold heat-source load accompanying the exhaust-heat utilization of production cooling water. Moreover, miniaturization of a refrigerating machine is attained and electricity expense for operation of the refrigerating machine can be reduced. If those savings are replaced by electricity expense, it becomes 150,000 kWh (about 2 million yen) saving per year, thereby acquiring a great saving effect in the running cost of a semiconductor manufacturing facility.

The present invention is not limited to the above-mentioned specifically disclosed embodiments, and variations and modifications may be made within the disclosure of the present invention.

1. An exhaust-heat utilization system of a semiconductor manufacturing facility having a plurality of semiconductor manufacturing apparatuses, comprising:
a low-temperature cooling-water supply line for supplying to the semiconductor manufacturing apparatuses a low-temperature cooling-water having a temperature substantially equal to a room temperature;
a medium-temperature cooling-water supply line for supplying a medium-temperature cooling-water to a first predetermined semiconductor manufacturing apparatus, the medium-temperature cooling-water being exhausted from the semiconductor manufacturing apparatuses and having a temperature higher than the room temperature; and
a high-temperature cooling-water supply line for supplying, as a heating source, a high-temperature cooling-water to a third predetermined semiconductor manufacturing apparatus, the high-temperature cooling-water being exhausted from a second predetermined semiconductor manufacturing apparatus and having a temperature higher than a temperature of the medium-temperature cooling-water.

2. The exhaust-heat utilization system as claimed in claim 1, further comprising:
a medium-temperature cooling-water tank for temporarily storing the medium-temperature cooling-water exhausted from the semiconductor manufacturing apparatuses;
a medium-temperature cooling-water circulation line for supplying the medium-temperature cooling-water stored in said medium-temperature cooling-water tank to said medium-temperature cooling-water supply line;
a low-temperature cooling-water circulation line for supplying the medium-temperature cooling-water stored in said medium-temperature cooling-water tank to said low-temperature cooling-water supply line; and
a water-cooling type cooling apparatus provided to said low-temperature cooling-water circulation line so as to cool the medium-temperature cooling-water from said medium-temperature cooling-water tank.

3. The exhaust-heat utilization system as claimed in claim 2, further comprising a heat exchanger provided to said low-temperature cooling-water circulation line so as to cool the cooling water from said water-cooling type cooling apparatus to be the low-temperature cooling-water.

4. The exhaust-heat utilization system as claimed in one of claims 1 to 3, further comprising a high-temperature cooling-water tank which temporarily stores a high-temperature cooling-water exhausted from the semiconductor manufacturing apparatuses, wherein said high-temperature cooling-water supply line is connected to said high-temperature cooling-water tank.

5. The exhaust-heat utilization system as claimed in one of claims 1 to 3, wherein said first predetermined semiconductor manufacturing apparatus is a coater/developer apparatus.

6. The exhaust-heat utilization system as claimed in one of claims 1 to 3, wherein said second predetermined semiconductor manufacturing apparatus is a heat treatment apparatus having a heating furnace.

7. The exhaust-heat utilization system as claimed in one of claims 1 to 3, wherein said third predetermined semiconductor manufacturing apparatus includes at least one of a wafer cleaning apparatus and an etching apparatus.

8. An exhaust-heat utilization method of a semiconductor manufacturing facility having a plurality of semiconductor manufacturing apparatuses, comprising the steps of:
supplying a low-temperature cooling-water having a temperature substantially equal to a room temperature to the semiconductor manufacturing apparatuses;
supplying a medium-temperature cooling-water to a first predetermined semiconductor manufacturing apparatus, the medium-temperature cooling-water being exhausted from the semiconductor manufacturing apparatuses and having a temperature higher than the room temperature; and
supplying, as a heating source, a high-temperature cooling-water to a third predetermined semiconductor apparatus as a heating source, the high-temperature cooling-water exhausted from a second predetermined semiconductor manufacturing apparatus and having a temperature still higher than the medium-temperature cooling-water.

9. The exhaust-heat utilization method as claimed in claim 8, further comprising the steps of:
temporarily storing the medium-temperature cooling-water exhausted from the semiconductor manufacturing apparatus;
supplying a part of the stored medium-temperature cooling-water to said first predetermined semiconductor manufacturing apparatus; and
cooling a remaining part of the stored medium-temperature cooling-water by a water-cooling type cooling apparatus and supplying the cooled medium-temperature cooling-water to the semiconductor manufacturing apparatuses.

10. The exhaust-heat utilization method as claimed in claim 9, further comprising a step of cooling further the medium-temperature cooling-water cooled by the water-cooling type cooling apparatus by a heat exchanger.

11. A semiconductor manufacturing facility, comprising:
a plurality of semiconductor manufacturing apparatuses;
a low-temperature cooling-water supply line for supplying to the semiconductor manufacturing apparatuses a low-temperature cooling-water having a temperature substantially equal to a room temperature;
a medium-temperature cooling-water supply line for supplying a medium-temperature cooling-water to a first predetermined semiconductor manufacturing apparatus, the medium-temperature cooling-water being exhausted from the semiconductor manufacturing apparatuses and having a temperature higher than the room temperature; and
a high-temperature cooling-water supply line for supplying, as a heating source, a high-temperature cooling-water to a third predetermined semiconductor manufacturing apparatus, the high-temperature cooling-water being exhausted from a second predetermined semiconductor manufacturing apparatus and having a temperature higher than a temperature of the medium-temperature cooling-water.

12. The semiconductor manufacturing facility as claimed in claim 11, further comprising:
a medium-temperature cooling-water tank for temporarily storing the medium-temperature cooling-water exhausted from the semiconductor manufacturing apparatuses;
a medium-temperature cooling-water circulation line for supplying the medium-temperature cooling-water stored in said medium-temperature cooling-water tank to said medium-temperature cooling-water supply line;
a low-temperature cooling-water circulation line for supplying the medium-temperature cooling-water stored in said medium-temperature cooling-water tank to said low-temperature cooling-water supply line; and
a water-cooling type cooling apparatus provided to said low-temperature cooling-water circulation line so as to cool the medium-temperature cooling-water from said medium-temperature cooling-water tank.

13. The semiconductor manufacturing facility as claimed in claim 12, further comprising:
a heat exchanger provided to said low-temperature cooling-water circulation line so as to cool the cooling water from said water-cooling type cooling apparatus to be the low-temperature cooling-water.

14. The semiconductor manufacturing facility as claimed in one of claims 11-13, further comprising a high-temperature cooling-water tank which temporarily stores a high-temperature cooling-water exhausted from the semiconductor manufacturing apparatuses, wherein said high-temperature cooling-water supply line is connected to said high-temperature cooling-water tank.

15. A heat recovery system of a semiconductor manufacturing plant having a plurality of semiconductor manufacturing apparatuses and an outside-air conditioning unit which supplies an outside air to the semiconductor manufacturing apparatuses after applying an air-conditioning process, comprising two cooling-water systems that are a cooling-water supply system which supplies a cooling water of a room temperature for cooling said semiconductor manufacturing apparatuses, and a cooling-water recovery system including piping, a tank and a pump for recovering the cooling water that is exhausted after cooling said semiconductor manufacturing apparatuses, wherein the cooling water exhausted from said semiconductor manufacturing apparatuses and recovered by said cooling-water recovery system is supplied to other semiconductor manufacturing apparatuses requiring heating and/or said outside-air conditioning unit.

16. The heat recovery system as claimed in claim 15, wherein said semiconductor manufacturing apparatuses are vertical-type furnaces which thermally oxidize silicon wafers, and the cooling water recovered by said cooling-water recovery system is supplied to an air heater of said outside-air conditioning unit.
